(19) United States
(12) Patent Application Publication
(10) Pub. No.: US 2019/0176376 A1
(43) Pub. Date: Jun. 13, 2019

(54) PATTERN FORMING METHOD AND DEVICE

(71) Applicant: Panasonic Intellectual Property Management Co., Ltd., Osaka (JP)

(72) Inventors: MICHIRU KUROMIYA, Osaka (JP); AKIHIRO ISHIKAWA, Fukuoka (JP)

(21) Appl. No.: 16/205,172

(22) Filed: Nov. 29, 2018

(30) Foreign Application Priority Data
Dec. 11, 2017 (JP) 2017-236573

(51) Int. Cl. B29C 43/32; B29C 43/02; B29C 35/08

(52) U.S. Cl. CPC B29C 43/32; B29C 43/021; B29C 2035/0827; B29C 2043/3266; B29C 35/0805

(57) ABSTRACT

A method and a device for forming a pattern improve transfer accuracy by reducing the number of fine bubbles remaining in a transfer material, and the number of bubbles that remain in a pattern when the pressure application on a film is finished before the transfer material completely fills the mold pattern. The method and a device include: filling a pattern of a mold with a transfer material by applying an ultrasonic vibration to the transfer material; and transferring the transfer material filling the pattern to a transfer target.

### TECHNICAL FIELD

The technical field relates to a method and a device for forming patterns using an imprint technique.

### BACKGROUND

In optical parts used for products such as displays and lighting, there is a demand for the development of a device equipped with new functions that control reflection and diffraction of light. There is also a demand for miniaturization of wires for high integration of semiconductors such as system LSIs. These demands are met by, for example, forming nanometer (nm)- to micrometer (μm)-scale fine patterns that exhibit special optical characteristics. Imprinting has attracted interest as a technique for forming such fine structures. In this technique, a mold with predefined surface patterns is used to form patterns by pressing the mold against a resin applied to a substrate surface.

With reference to FIGS. 4 and 5, the following describes typical pattern-forming procedures of UV (ultraviolet) imprinting, a type of imprinting technique. FIG. 4 is a schematic view representing steps of a common plate imprinting process. First, in step (a) of FIG. 4, a mold 42 with a predefined pattern (irregularities) is placed on a flat stage 41, and a transfer material 43 is applied to the mold 42 with, for example, a dispenser or an inkjet device. Alternatively, the transfer material 43 is applied to the mold 42 in advance, and the mold 42 is placed on the stage 41. In step (b) of FIG. 4, a cylindrical roller 45 is conveyed over the top surface of a film 44 to linearly press the film 44, filling the pattern of the mold 42 with the transfer material 43. In step (c) of FIG. 4, the transfer material 43 is cured by applying UV light from above the film 44, using a UV irradiator 49. Finally, in step (d) of FIG. 4, the film 44 is moved diagonally or vertically above the mold 42 to release the transfer material 43 from the mold 42. After these steps, the irregularities of the pattern of the mold 42 are formed on the film (a transfer target) in inverted form.

FIG. 5, (b-1) is a schematic view magnifying the region filled with the transfer material in step (b) of FIG. 4 in the above transfer method. FIG. 5, (b-2) is a schematic view magnifying the shape of the transferred material after curing in step (c) of FIG. 4. As shown in (b-1) of FIG. 5, fine bubbles 52 present in the transfer material 53 remain even after filling the transfer material 53. The fine bubbles 52 create a defective portion in the pattern after curing, as shown in (b-2) of FIG. 5. Bubbles 51 also remain in the pattern, as shown in (b-1) of FIG. 5. These phenomena occur when, for example, the pressure application by the rolling cylindrical roller 45 on the top surface of the film 44 is finished before the transfer material 43 completely fills the pattern of the mold 42 in step (b) of FIG. 4. This creates defective portions due to the bubbles 51 in the shape of the cured pattern, as shown in (b-2) of FIG. 5. These defective portions result in poor transfer accuracy.

### SUMMARY

A method is known that is intended to solve this problem by performing an imprinting process in a condensable gas, as described in JP-A-2004-103817. The method can reduce the pattern shape defects due to the remaining bubbles 51 in the pattern.

However, it is not possible with the method of the related art to reduce defective portions created in the pattern by the fine bubbles remaining in the transfer material. Another drawback is that the transfer material absorbs the condensable gas, and disrupts the shape of the transferred pattern. This leads to poor transfer accuracy.

It is accordingly an object of the present disclosure to provide a method and a device for forming a pattern with improved transfer accuracy by reducing the number of fine bubbles remaining in the transfer material, and the number of bubbles that remain in the pattern when the pressure application on a film is finished before the transfer material completely fills the mold pattern.

A method for forming a pattern according to an aspect of the present disclosure includes:

a step A of filling a pattern of a mold with a transfer material; and

a step B of transferring the transfer material filling the pattern to a transfer target,

wherein an ultrasonic vibration is applied to the transfer material in the step A.

A device for forming a pattern according to an aspect of the present disclosure includes:

a pressing tool that presses a mold or a transfer target against a transfer material;

a curing unit that cures the transfer material filled in a pattern of the mold by the pressing tool;

an ultrasonic generator; and

a controller,

wherein the controller causes the ultrasonic generator to apply an ultrasonic vibration to the transfer material being filled into the pattern by the pressing tool.

The method and the device for forming a pattern according to the aspects of the present disclosure can improve transfer accuracy by reducing the number of fine bubbles remaining in the transfer material, and the number of bubbles that remain in the pattern when the pressure application on a film is finished before the transfer material completely fills the mold pattern.

### BRIEF DESCRIPTION OF THE DRAWINGS

FIG. 1 is a cross sectional view schematically representing a pattern forming device of an embodiment of the present disclosure.

FIG. 2 is a cross sectional view schematically representing an imprinting process of an embodiment of the present disclosure.

FIG. 3 is a cross sectional view schematically representing an imprinting process of another embodiment of the present disclosure.

FIG. 4 is a cross sectional view schematically representing a related art plate imprinting process.

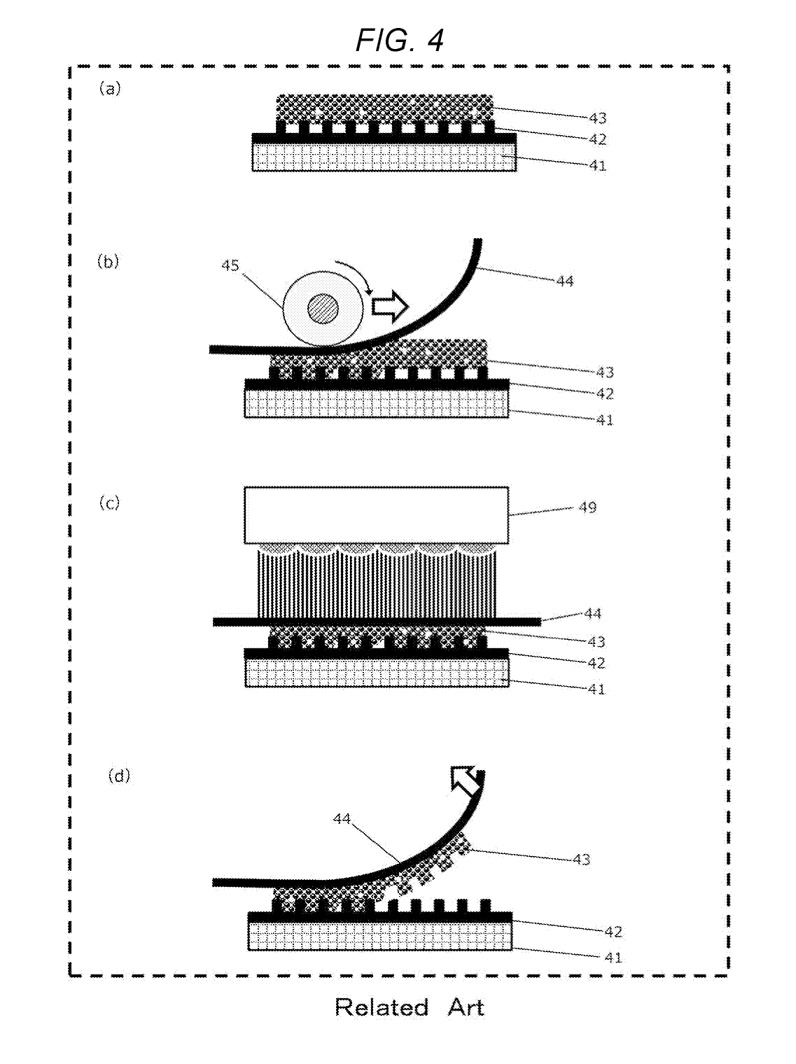

FIG. 5 is a cross sectional view magnifying the region filled with a transfer material, and the shape of the transferred material in the related art plate imprinting process.

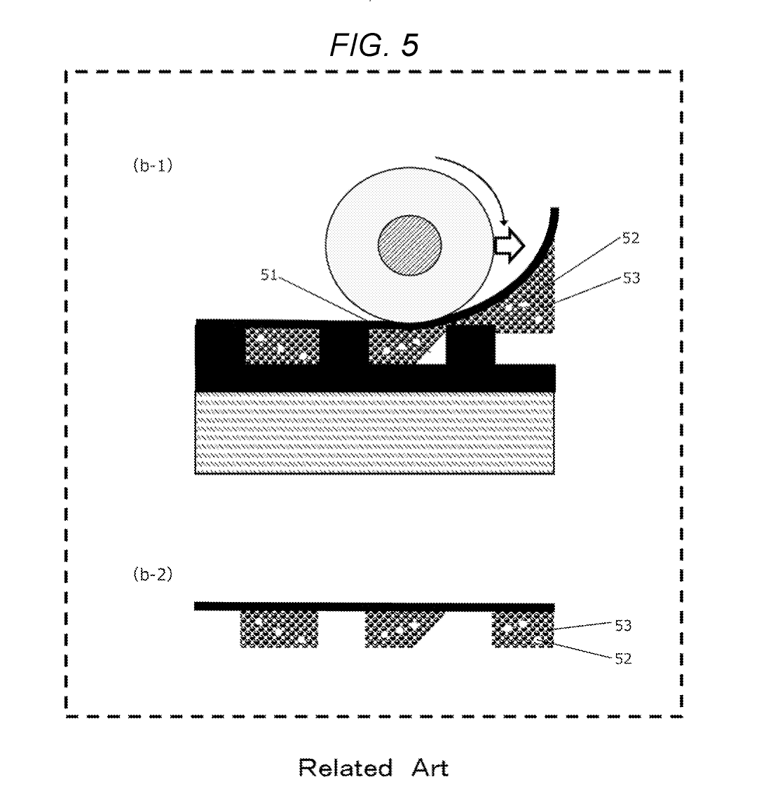

### DESCRIPTION OF EMBODIMENTS

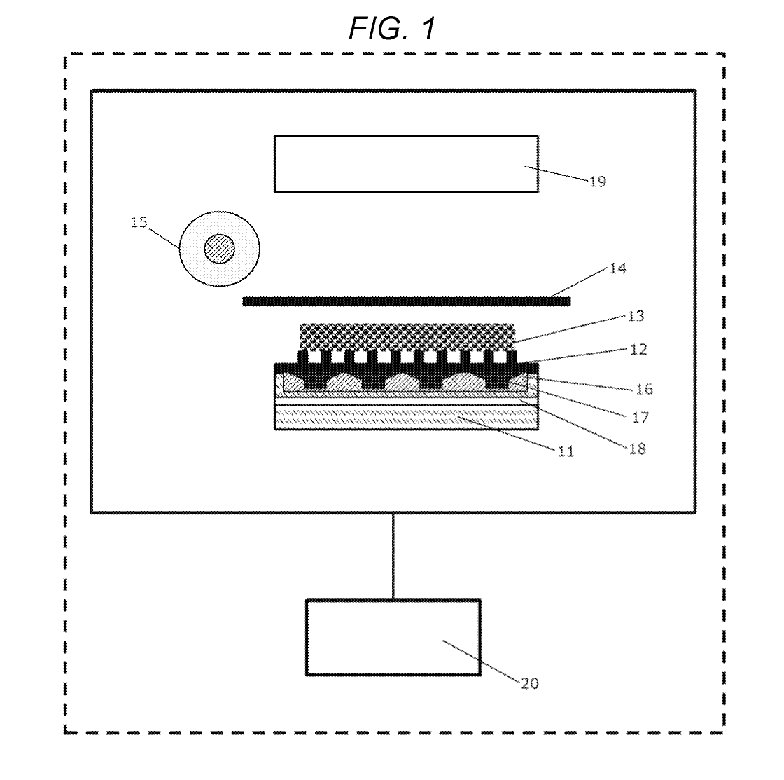

Embodiments of the present disclosure are described below, with reference to the accompanying drawings. FIG. 1 shows a pattern forming device of an embodiment of the present disclosure. The pattern forming device includes a pressing tool that presses a transfer material; a curing unit that cures the transfer material; an ultrasonic generator; and a controller. The pattern forming device of the embodiment of the present disclosure is configured from a stage 11, a mold 12 with a predefined pattern (irregularities), a transfer material 13, a film 14 (a transfer target), a roller 15 (a pressing tool), an ultrasonic transducer 16 (an ultrasonic generator), an oscillator 17 installed in the ultrasonic transducer 16, a channel 18 (a temperature adjuster), a UV irradiator 19 (a curing unit), and a controller 20 that controls operations of these members.

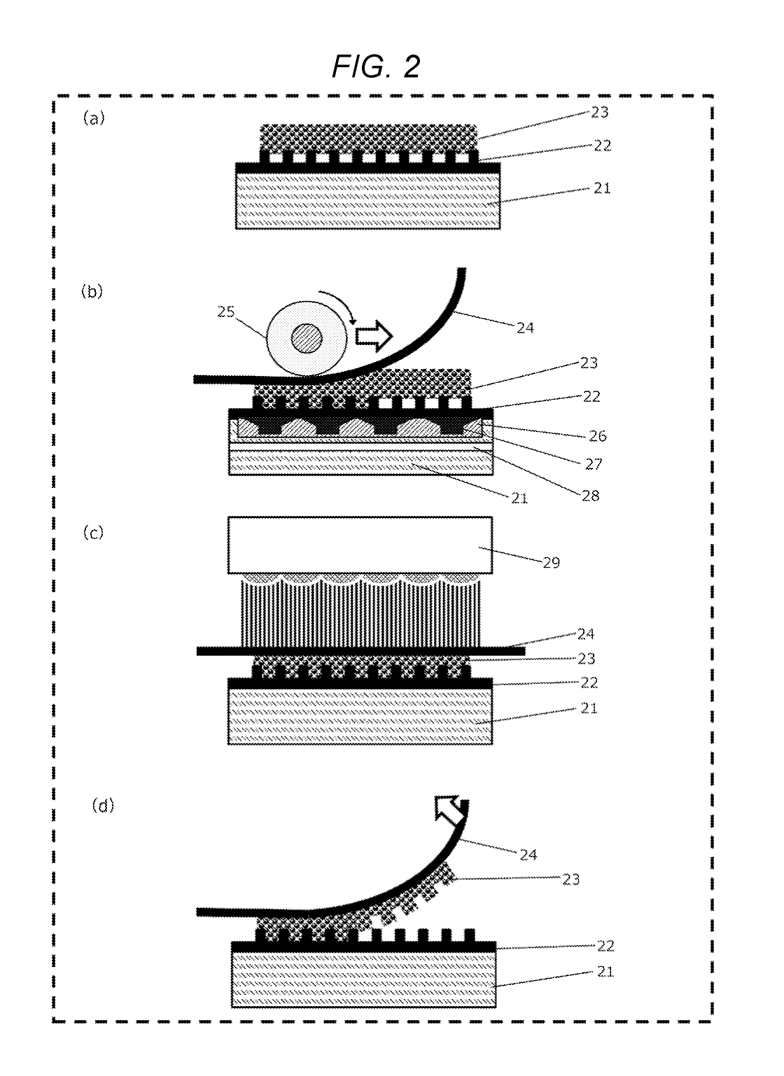

A pattern forming method using the pattern forming device is described below. FIG. 2 represents steps of the pattern forming method of an embodiment of the present disclosure. First, in step (a) of FIG. 2, a mold 22 is placed on a flat stage 21, and a transfer material 23 is applied to at least a part of the mold 22. Alternatively, the transfer material 23 may be applied to the mold 22 in advance, and the mold 22 may be placed on the stage 21. Inside the stage 21 are provided an ultrasonic generator, and a temperature adjuster that cools the transfer material 23 via the mold 22 to attain a controlled constant temperature.

The material of the mold 22 is not particularly limited, as long as it has the properties required as a mold, including rigidity and hardness. For example, the mold 22 may be made of a metallic material, or a resin material. The metallic material is desirably a material, for example, nickel, that is easily releaseable from the transfer material 23. The resin material may be, for example, a material having a fine UV curable resin pattern formed on a PET film by imprinting.

The transfer material 23 may be selected from various UV curable resins, for example, such as a urethane acrylate resin, an epoxy acrylate resin, a polyester acrylate resin, and an acryl acrylate resin. The transfer material 23 may be appropriately selected, taking into consideration factors such as the shape of a film 24, and the quantity of UV light needed for curing.

The method used to apply the transfer material 23 to the whole surface of the mold 22 may be appropriately selected according to the properties of the transfer material 23, and the shape of the film 24. Examples of usable methods include dispenser coating, roll coating, gravure coating, and screen coating.

On the patterned surface of the mold 22, a release layer may be formed over the pattern to improve releasability from the transfer material 23. The release layer is formed by bonding a coupling agent to the top surface of the pattern. By forming the release layer using a coupling agent, an extremely thin film as thin as, for example, a monomolecular film, can be formed, and the influence of the release layer on the transferred shape can be greatly reduced. The coupling agent may use various metal alkoxides of elements, for example, such as Ti, Li, Si, Na, K, Mg, Ca, St, Ba, Al, In, Ge, Bi, Fe, Cu, Y, Zr, and Ta. Particularly preferred are Si-containing metal alkoxides, specifically, a silane coupling agent.

In step (b) of FIG. 2, an ultrasonic vibration is generated by applying an AC voltage to the oscillator 27 installed in the ultrasonic transducer 26, and the ultrasonic vibration is applied to the transfer material 23 through the bottom surface of the mold 22. Under the ultrasonic vibration, a cylindrical roller 25 is conveyed on the top surface of the film 24 to linearly press the film 24, and fill the transfer material 23 in the pattern of the mold 22.

The roller 25, which has a cylindrical shape in this embodiment, is not limited to such a shape, provided that it can press the film 24 in a linear fashion. For example, the film 24 can be linearly pressed with an end portion of a polyhedral object, or with a surface of a thin plate by conveying these objects. When using objects of such shapes, damage to the film 24 can be prevented by chamfering the object before use.

Inside the ultrasonic transducer 26, a magnetostrictive material or a piezoelectric material is installed as the oscillator 27 that generates ultrasonic waves. Examples of the magnetostrictive material include iron, and an iron-gallium alloy. Examples of the piezoelectric material include piezoelectric ceramics such as barium titanate, and lead titanate; piezoelectric thin films such as zinc oxide, and lead zirconate titanate; vinylidene fluoride; and trifluoroethylene copolymers. Under applied AC voltage, the magnetostrictive material or the piezoelectric material provided as the oscillator 27 of the ultrasonic transducer 26 expands and contracts in a repeated fashion, and the resulting vibrations generate ultrasonic waves.

When ultrasonic vibrations are applied to a liquid, a liquid is alternately subjected to positive and negative pressure due to the acoustic pressure cycle of ultrasonic waves, and bubbles in the liquid are compressed under positive pressure, and decompressed under negative pressure. Under negative pressure, the bubbles expand into vacuum bubbles, and crush when subjected to positive pressure again. This phenomenon is called cavitation, and can be used to crush bubbles in a liquid, or eliminate bubbles in a liquid with the impact of crushing vacuum bubbles. Applying ultrasonic vibrations to a liquid also causes the liquid to flow in a straight line under the acoustic pressure. Such a straight flow of liquid causes convection, agitating and dispersing the bubbles in the liquid, and releasing the bubbles into the atmosphere from the liquid. That is, fine bubbles remaining in the transfer material 23, and bubbles that remain in the pattern when the pressure application on the film 24 is finished before the transfer material 23 completely fills the pattern can be eliminated by cavitation, or can be released into the atmosphere by the effect of a straight flow by filling the pattern of the mold 22 with the transfer material 23 under applied ultrasonic vibrations to the transfer material 23.

The ultrasonic waves (frequencies greater than 20 kHz) used in the ultrasonic generator of the present disclosure are low-frequency ultrasonic waves with a frequency of no greater than 1 MHz. Frequencies greater than 500 kHz raise the threshold for inducing cavitation, and it becomes necessary to apply ultrasonic waves for a long time period to eliminate bubbles and fine bubbles. This reduces the efficiency of pattern formation. In order to generate a straight flow, it is desirable to apply a frequency of at least 100 kHz, and provide a sufficient vibrational energy. It is accordingly desirable that the frequency be 100 kHz to 500 kHz to efficiently eliminate or release the fine bubbles or bubbles.

Desirably, ultrasonic waves are applied at controlled frequencies that vary with the size of the bubbles remaining in the pattern. Cavitation can be enhanced, and larger bubbles can be more effectively eliminated by applying ultrasonic waves of lower frequencies and larger wavelengths. Conversely, smaller bubbles can be more efficiently eliminated by allowing cavitation to occur more frequently with high-frequency vibrations produced by applying higher frequencies. The size of remaining bubbles in the pattern depends on two factors: the aspect ratio of the pattern, and the wettability of the transfer material 23.

The aspect ratio is a normalized value of a groove depth of the pattern with respect to a groove width. Contrary to the simplified shape of the pattern schematically represented in FIG. 2, the pattern in the surface of the mold 22 includes patterns of various aspect ratios in actual practice. The bubble size increases as the aspect ratio increases, and decreases as the aspect ratio decreases. It is accordingly desirable to increase frequency when the aspect ratio is large.

In order to more effectively eliminate bubbles, it is desirable to store an aspect ratio of the pattern in advance along with a corresponding frequency value, and control the frequency according to the aspect ratio of the pattern to be filled with the transfer material 23, using the pre-stored corresponding frequency value. Alternatively, detecting means that detects the aspect ratio of the pattern to be filled with the transfer material 23 may be provided, and the frequency may be controlled by using pre-stored corresponding frequency values for different aspect ratios after collating the detected aspect ratio by the detecting means with the pre-stored aspect ratios. For example, a frequency a1 corresponding to an aspect ratio A1 of the pattern is stored beforehand, and the frequency is changed to a1 when the pattern to be filled with the transfer material 23 has aspect ratio A1.

For simpler control of the ultrasonic generator, it is desirable to control frequency as follows. A mean value of aspect ratios of the pattern is found, and a reference frequency value is set for the mean value. The frequency is then controlled according to the result of a comparison of the mean value with the aspect ratio of the pattern to be filled with the transfer material 23, using the reference frequency value. For example, when the aspect ratio of the pattern is larger than the mean value, a frequency higher than the reference value is set because higher frequencies are desirable for larger aspect ratios, as stated above.

The wettability of the transfer material 23 can be considered as two separate properties: one for the film 24, and one for the mold 22. The transfer material 23 show different wettability for the film 24 when the surface state of the film 24 is different, for example, when the film 24 uses a different material in a part of the film, or when another transfer material has already been formed on a part of the film 24. The bubble size increases as the wettability of the transfer material 23 for the film 24 improves, and decreases as the wettability of the transfer material 23 for the film 24 becomes poor. It is accordingly desirable to increase frequency when the film 24 has a larger contact angle for the transfer material 23.

In order to more effectively eliminate bubbles, it is desirable to store a contact angle of the film 24 for the transfer material 23 in advance along with a corresponding frequency value, and control the frequency according to the contact angle between the film 24 and the transfer material 23 to be pressed with the film 24, using the pre-stored corresponding frequency value. Alternatively, detecting means that detects the surface state of the film 24 used to press the transfer material 23, or that detects the contact angle between the film 24 and the transfer material 23 may be provided, and the frequency may be controlled by using pre-stored corresponding frequency values for different surface states or contact angles after collating the detected surface state or contact angle by the detecting means with the pre-stored surface states or contact angles. For example, a frequency b1 is stored that corresponds to a contact angle B1 of the film 24 for the transfer material 23, and the frequency is changed to b1 when the film 24 used to press the transfer material 23 has contact angle B1.

For simpler control of the ultrasonic generator, it is desirable to control frequency as follows. A mean value of contact angles of the film 24 for the transfer material 23 is found, and a reference frequency value is set for the mean value. The frequency is then controlled according to the result of a comparison of the mean value with the contact angle between the film 24 and the transfer material 23 to be pressed with the film 24, using the reference frequency value. For example, when the contact angle between the film 24 and the transfer material 23 is larger than the mean value, a frequency higher than the reference value is set because higher frequencies are desirable for larger contact angles, as stated above.

When controlling frequency in the manner described above, bubbles can be effectively eliminated by preferably applying an ultrasonic vibration to a position corresponding to the pattern being filled or to the film 24 being pressed. It is accordingly desirable to locate the position of the pattern or the film 24 being pressed with the roller 25, and control the frequency of ultrasonic waves according to the located position of the pattern or the film 24. For example, a position can be located by storing the conveyance direction and speed of the roller 25, or by using a sensor that detects pressure and movement, or by capturing an image of the mold 22 and the film 24 with an image capturing device equipped with an imaging device.

In-plane vibration of the mold 22 at different frequencies can be achieved with the use of the ultrasonic transducer 26 that includes a plurality of magnetostrictive materials or piezoelectric materials as the oscillator 27.

Unlike bubbles that remain in the pattern, the fine bubbles remaining in the transfer material 23 are not introduced in the step of filling the transfer material 23 into the pattern. Accordingly, the fine bubbles may be eliminated by cavitation, or may be released into the atmosphere with a straight flow by applying ultrasonic vibrations to the transfer material 23 before pressing.

When applying ultrasonic vibrations, it is preferable to cool the transfer material 23 via the mold 22 by sending coolant water or a coolant gas to a channel 28 provided in the stage 21. This is to prevent a temperature increase in the mold 22 and in the transfer material 23 via the mold, and viscosity fluctuations in the transfer material 23 due to application of ultrasonic vibrations.

When the temperature of the transfer material 23 becomes higher than 2.5° C. above room temperature, the viscosity of the transfer material 23 decreases, and this results in changes in the thickness of the transferred object, and thus poor accuracy. Conversely, the viscosity of the transfer material 23 increases when the temperature of the transfer material 23 becomes lower than 2.5° C. below room temperature. This encourages generation of remaining bubbles in the pattern, or influences the bubble size. It is accordingly desirable to control the temperature within ±2.5° C. of room temperature. Optimally, the temperature is controlled within ±0.5° C. of room temperature.

In order to more reliably control temperature, it is preferable to provide a temperature detector, and control temperature by using the detected information. The temperature detector may be, for example, a non-contact sensor that makes use of infrared rays or luminance to measure temperature, or a contact sensor that takes advantage of magnetism or electrical resistance changes.

Temperature control of the transfer material 23 is not limited to the channel 28 that cools the transfer material 23 via the mold 22 with a flow of coolant water or coolant gas, provided that a temperature change of the transfer material 23 can be reduced. For example, it is possible to use a temperature adjuster using a cooling fan, or a temperature adjuster using a refrigerant.

In step (c) of FIG. 2, the transfer material 23 is cured by applying UV light from a UV irradiator 29 from above the film 24, in the absence of ultrasonic vibration application.

Here, the film 24, which is a UV transmissive translucent material, may be, for example, a PET film. However, the film 24 is not limited to a PET film. The UV irradiator 29 may be, for example, an LED. However, the UV irradiator 29 is not limited to an LED, provided that it is a device that cures the transfer material 23.

The above embodiment of the present disclosure is based on pattern formation by UV imprinting. However, the disclosure also can be implemented by a similar process using thermal imprinting or photo imprinting. In this case, the transfer material 23 is cured by applying heat or light.

In step (d) of FIG. 2, the film 24 is moved diagonally or vertically above the mold 22 to release the transfer material 23 from the mold 22. Here, the film 24 can be released from the mold 22 with a smaller resistance, and the transferred shape becomes more desirable when the film 24 is slowly released from the mold 22 with a smaller release angle.

In the steps of the pattern forming method described above, the pattern forming device is controlled by the controller 20 connected to the device with wires or without wires, as shown in FIG. 1. The above embodiment of the present disclosure is based on an example in which the pattern forming device is controlled as a whole by a single controller 20. The controller 20 can be a general purpose CPU executing instructions in an associated memory or an application specific integrated circuit (ASIC) including the memory. Moreover, more than one controller may be present.

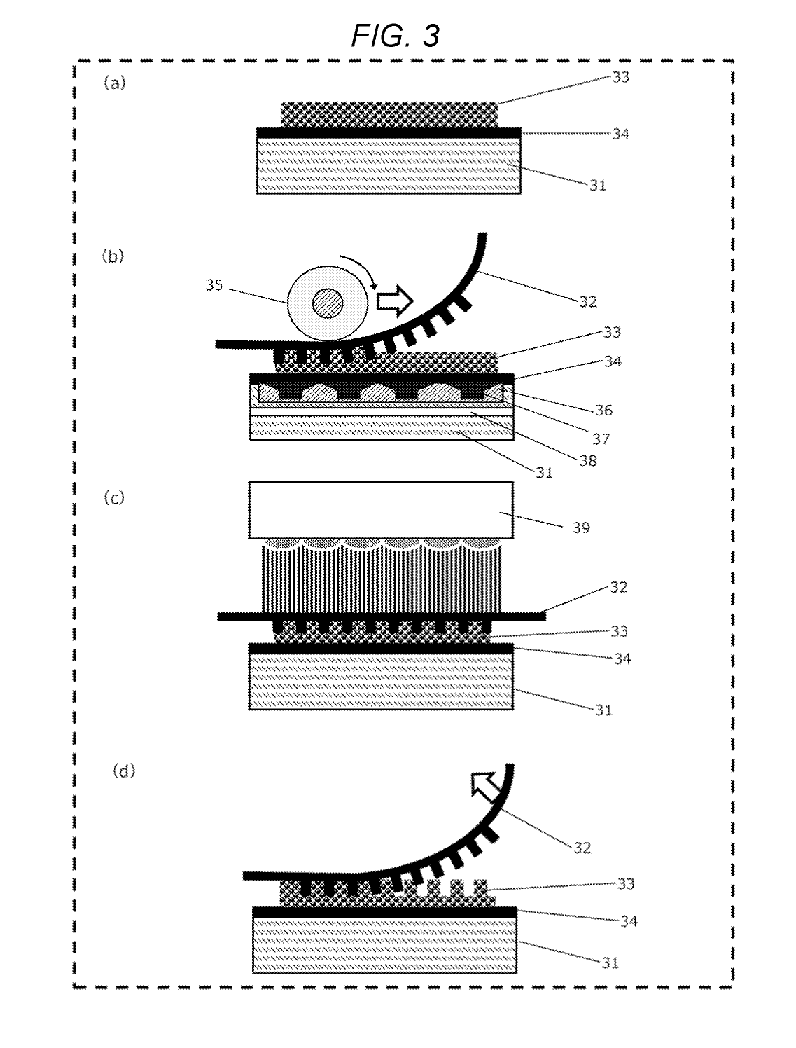

The mold 22 and the film 24 of the embodiment may be disposed in opposite orientation from that shown in FIG. 2. Specifically, as shown in FIG. 3, a film 34 may be placed on a stage 31 equipped with an ultrasonic generator and a temperature adjuster, and a transfer material 33 may be pressed with a mold 32 after applying the transfer material 33 to at least a part of the film 34. In this case, an ultrasonic vibration is generated by applying AC voltage to an oscillator 37 installed in an ultrasonic transducer 36, and the ultrasonic vibration is applied to the transfer material 33 through the bottom surface of the film 34. The transfer material 33 is cooled via the film 34 with a flow of coolant water or coolant gas in a channel 38.

The material of the mold 32 needs to be transmissive to UV light applied from above by the UV irradiator 39, and be bendable to follow the shape of the cylindrical roller 35, in addition to having the properties required as a mold, including rigidity and hardness. For example, the mold 32 may be one having a fine UV curable resin pattern formed on a PET film by imprinting.

With the foregoing configuration, the transfer accuracy can improve with reduced numbers of fine bubbles remaining in the transfer material, and with reduced numbers of bubbles that remain in the pattern when the pressure application on a film is finished before the transfer material completely fills the mold pattern.

The present disclosure enables accurate pattern formation, and is useful, for example, as an imprinting method and an imprinting device that transfers a pattern to a transfer target.

What is claimed is:

1. A method for forming a pattern, the method comprising:
filling a pattern of a mold with a transfer material; and
applying an ultrasonic vibration to the transfer material to transfer the transfer material filling the pattern to a transfer target.

2. The method according to claim 1, further comprising curing the transfer material by applying ultraviolet light.

3. The method according to claim 1, wherein:
the filling of the pattern of the mold further includes pressing the transfer target against the transfer material applied to a surface of the mold, and
the ultrasonic vibration is applied from a location opposite the transfer material with the mold in between.

4. The method according to claim 1, wherein:
the filling of the pattern of the mold further includes pressing the mold against the transfer material applied to a surface of the transfer target, and
the ultrasonic vibration is applied from a location opposite the transfer material with the transfer target in between.

5. The method according to claim 1, wherein the ultrasonic vibration has a frequency of 100 kHz to 500 kHz.

6. The method according to claim 1, wherein:
a preset value corresponding to an aspect ratio of the pattern is set for the ultrasonic vibration in a 100 kHz to 500 kHz frequency range, and
the ultrasonic vibration is controlled by varying a frequency of the ultrasonic vibration according to the aspect ratio of the pattern being filled with the transfer material, using the preset corresponding value.

7. The method according to claim 1, wherein:
a preset reference value for a mean value of aspect ratios of the pattern is set for the ultrasonic vibration in a 100 kHz to 500 kHz frequency range, and
the ultrasonic vibration is controlled by varying a frequency of the ultrasonic vibration according to an aspect ratio of the pattern being filled with the transfer material, using the preset reference value.

8. The method according to claim 7, wherein the ultrasonic vibration is controlled by setting a frequency higher than the reference value when the aspect ratio of the pattern being filled with the transfer material is greater than the mean value.

9. The method according to claim 1, wherein:
a preset value corresponding to a contact angle of the transfer target for the transfer material is set for the ultrasonic vibration in a 100 Hz to 500 Hz frequency range, and
the ultrasonic vibration is controlled by varying a frequency of the ultrasonic vibration according to the contact angle between the transfer material and the transfer target pressing the transfer material or being pressed to fill the transfer material, using the preset corresponding value.

10. The method according to claim 1, wherein:
a preset reference value for a mean value of contact angles of the transfer target for the transfer material is set for the ultrasonic vibration in a 100 kHz to 500 kHz frequency range, and
the ultrasonic vibration is controlled by varying a frequency of the ultrasonic vibration according to a contact angle between the transfer material and the transfer target pressing the transfer material or being pressed to fill the transfer material, using the preset reference value.

11. The method according to claim 10, wherein:
the ultrasonic vibration is controlled by setting a frequency higher than the reference value when the contact angle between the transfer material and the transfer target pressing the transfer material or being pressed to fill the transfer material is greater than the mean value.

12. The method according to claim 1, wherein a temperature of at least a part of the transfer material is controlled within ±2.5° C. of a temperature before the application of the ultrasonic vibration while the ultrasonic vibration is being applied to the transfer material.

13. A device for forming a pattern, the device comprising:
a pressing tool that presses a mold or a transfer target against a transfer material;
a curing unit that cures the transfer material filled in a pattern of the mold by the pressing tool;
an ultrasonic generator; and
a controller configured to control the ultrasonic generator to apply an ultrasonic vibration to the transfer material being filled into the pattern by the pressing tool.

14. The device according to claim 13, wherein the curing unit cures the transfer material by applying ultraviolet light.

15. The device according to claim 13, wherein the ultrasonic generator is disposed in a position opposite the pressing tool with the transfer material in between.

16. The device according to claim 13, wherein the controller controls a frequency of the ultrasonic vibration in a frequency range of 100 kHz to 500 kHz.

17. The device according to claim 13, wherein:
a preset value corresponding to an aspect ratio of the pattern is set for the ultrasonic vibration in a 100 kHz to 500 kHz frequency range, and
the controller controls the ultrasonic vibration by varying a frequency of the ultrasonic vibration according to the aspect ratio of the pattern being filled with the transfer material, using the preset corresponding value.

18. The device according to claim 13, wherein:
a preset value corresponding to a contact angle representing wettability of the transfer target is set for the ultrasonic vibration in a 100 kHz to 500 kHz frequency range, and
the controller controls the ultrasonic vibration by varying a frequency of the ultrasonic vibration according to the contact angle representing wettability of the transfer target pressing the transfer material or being pressed to fill the transfer material, using the preset corresponding value.

19. The device according to claim 13, comprising:
a temperature detector; and
a temperature adjuster,
wherein the controller while the ultrasonic vibration is being applied to the transfer material causes the temperature adjuster to control a temperature of at least a part of the transfer material within ±2.5° C. of a temperature before the application of the ultrasonic vibration after detection of the transfer material temperature by the temperature detector.

20. The device according to claim 19, wherein the temperature adjuster is disposed in a position opposite the pressing tool with the transfer material in between.
